(19) United States
(12) Patent Application Publication
(10) Pub. No.: US 2015/0273520 A1
(43) Pub. Date: Oct. 1, 2015

(54) METHOD OF MANUFACTURING THREE-DIMENSIONAL STRUCTURE AND THREE-DIMENSIONAL STRUCTURE

(71) Applicant: SEIKO EPSON CORPORATION, Tokyo (JP)

(72) Inventor: Eiji OKAMOTO, Matsumoto (JP)

(21) Appl. No.: 14/662,779

(22) Filed: Mar. 19, 2015

(30) Foreign Application Priority Data
Mar. 26, 2014 (JP) 2014-063431

(51) Int. Cl. B05D 1/26

(52) U.S. Cl. CPC B05D 1/26; B33Y 10/00

(57) ABSTRACT

A method of manufacturing a three-dimensional structure using three-dimensional data includes: discharging ink containing a curable resin from a droplet discharge head having a plurality of nozzles; curing the discharged ink; and measuring discharge amounts of the ink in the plurality of nozzles to create discharge amount data. Here, the three-dimensional data is corrected based on the discharge amount data.

### BACKGROUND

1. Technical Field

The present invention relates to a method of manufacturing a three-dimensional structure and a three-dimensional structure.

2. Related Art

In the related art, for example, a method of forming a three-dimensional structure on the basis of a model of a three-dimensional object formed by three-dimensional CAD software or the like has been known.

As one method of forming a three-dimensional structure, a lamination method is known (for example, refer to JP-A-2000-280354). In the lamination method, generally, a model of a three-dimensional object is divided into a plurality of two-dimensional sectional layers, and then cross-sectional members corresponding to the respective two-dimensional cross-sectional layers are sequentially formed and laminated, thereby forming a three-dimensional structure.

In the lamination method, if only a model of a three-dimensional structure to be formed is present, it is possible to directly form a three-dimensional, and there is no need to fabricate a mold prior to forming. Therefore, it is possible to rapidly and inexpensively form a three-dimensional structure. Further, in the lamination method, thin plate-shaped cross-sectional members are laminated one by one, and thus it is possible to form a three-dimensional structure as an integrated structure without being divided into a plurality of parts even when the three-dimensional structure is a complex body having an inner structure.

Meanwhile, in the method in the related art, plane images (unit layers) obtained by dividing the three-dimensional data of a three-dimensional structure is drawn and laminated by discharging ink from an ink jet head having a plurality of nozzles to form a three-dimensional structure, but it is difficult to form unit layers having uniform thickness because the discharge amount of ink varies for each nozzle. Further, it is also considered to average the discharge amounts of ink while shifting the nozzles for discharging ink with respect to each lamination step, but, in this way, it is difficult to sufficiently average the discharge amounts of ink, and to correct the discharge amounts depending on the size of a three-dimensional structure to be formed.

### SUMMARY

An advantage of some aspect of the invention is to provide a method of manufacturing a three-dimensional structure, by which a three-dimensional structure can be efficiently formed with high dimensional accuracy, and to provide a three-dimensional structure manufactured with high dimensional accuracy.

The invention is realized in the following forms.

According to an aspect of the present invention, there is provided a method of manufacturing a three-dimensional structure using three-dimensional data, including: discharging ink containing a curable resin from a droplet discharge head having a plurality of nozzles; curing the discharged ink; and measuring discharge amounts of the ink in the plurality of nozzles to create discharge amount data, in which the three-dimensional data is corrected based on the discharge amount data.

Thus, it is possible to provide a method of efficiently manufacturing a three-dimensional structure with high dimensional accuracy.

In the method, the discharge amount data may be created based on the results obtained by discharging the ink from the plurality of nozzles to form a predetermined test pattern and then measuring the height of the test pattern of the ink in a discharge direction.

Thus, it is possible to create accurate discharge amount data and to further increase the dimensional accuracy of a three-dimensional structure to be manufactured.

In the method, in the ink discharge process, when several kinds of ink are discharged, the discharge amount data may be corrected using values of cure shrinkage of the several kinds of ink.

Thus, it is possible to create accurate discharge amount data and to further increase the dimensional accuracy of a three-dimensional structure to be manufactured.

In the method, the three-dimensional data may be corrected based on the discharge amount data and discharge position information of the plurality of nozzles.

Thus, it is possible to further increase the dimensional accuracy of a three-dimensional structure to be manufactured.

The method of manufacturing a three-dimensional structure may further include: creating two-dimensional sectional layer data by dividing the three-dimensional data of the three-dimensional structure into a plurality of two dimensional sectional layers, in which the two-dimensional sectional layer data are corrected based on the discharge amount data and discharge position information of the plurality of nozzles.

Thus, it is possible to further increase the dimensional accuracy of a three-dimensional structure to be manufactured.

The method of manufacturing a three-dimensional structure may further include: creating two-dimensional sectional layer data by dividing the three-dimensional data of the three-dimensional structure into a plurality of two dimensional sectional layers, in which, in the ink discharge process, the process is performed by superimposing the differential data of discharge amount of the nozzle having the maximum discharge amount of the plurality of nozzles and discharge amount of each of the plurality of other nozzles on a portion of the two-dimensional sectional layer data, the portion corresponding to the plurality of other nozzles.

Thus, it is possible to further increase the dimensional accuracy of a three-dimensional structure to be manufactured.

The method of manufacturing a three-dimensional structure may further include: creating two-dimensional sectional layer data by dividing the three-dimensional data of the three-dimensional structure into a plurality of two dimensional sectional layers, in which, in the ink discharge process, the process is performed by subtracting the differential data of discharge amount of the nozzle having the maximum discharge amount of the plurality of nozzles and discharge amount of each of the plurality of other nozzles from a portion of the two-dimensional sectional layer data, the portion corresponding to the plurality of nozzles.

Thus, it is possible to further increase the dimensional accuracy of a three-dimensional structure to be manufactured.

The method of manufacturing a three-dimensional structure may further include: creating two-dimensional sectional layer data by dividing the three-dimensional data of the three-dimensional structure into a plurality of two dimensional sectional layers, in which, in the ink discharge process, a portion of the two-dimensional sectional layer data, the portion corresponding to the plurality of nozzles, is corrected based on the differential data of the average discharge amount of the plurality of nozzles and the discharge amount of each of the plurality of nozzles.

Thus, it is possible to easily correct the discharge amount of each nozzle.

According to another aspect of the invention, there is provided a three-dimensional structure, which manufactured by the method.

Thus, it is possible to provide a three-dimensional structure manufactured with high dimensional accuracy.

### BRIEF DESCRIPTION OF THE DRAWINGS

The invention will be described with reference to the accompanying drawings, wherein like numbers reference like elements.

FIGS. 1A and 1B are cross-sectional views showing three-dimensional data before and after correction.

### DESCRIPTION OF EXEMPLARY EMBODIMENTS

Hereinafter, preferred embodiments of the invention will be described in detail with reference to the accompanying drawing.

### 1. Method of Manufacturing Three-Dimensional Structure

First, the method of manufacturing a three-dimensional structure according to the invention is described.

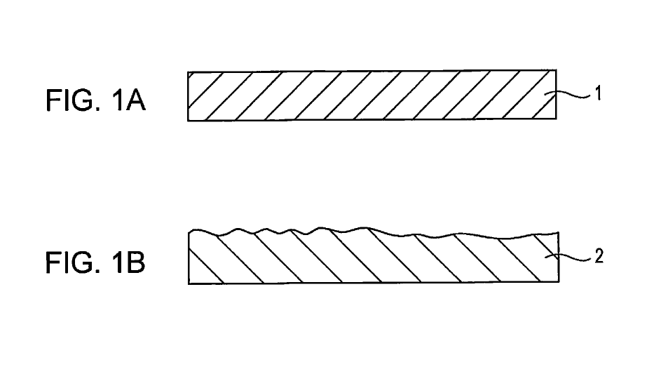

FIGS. 1A and 1B are cross-sectional views showing three-dimensional data before and after correction.

The manufacturing method according to the invention is a method of manufacturing a three-dimensional structure by laminating unit layers.

The method of manufacturing a three-dimensional structure according to the present embodiment includes: an ink discharge process of discharging curable ink containing a curable resin from a droplet discharge head having a plurality of nozzles to form an ink layer; and a curing process of curing the formed ink layer to form a unit layer. These processes are sequentially repeated to laminate the unit layers, thereby obtaining a three-dimensional structure.

The method of the invention is characterized in that, in the ink discharge process, the three-dimensional data of a three-dimensional structure is corrected based on the discharge amount data of curable ink discharged through the plurality of nozzles. By having such characteristics, it possible to suppress the variation in thickness of the layers without adjusting the discharge amount of curable ink through the plurality of nozzles to be constant even when the difference in discharge amount in the plurality of nozzles occurs, and thus it is possible to manufacture a three-dimensional structure having high dimensional accuracy.

### Creation of Discharge Amount Data

First, the creation of discharge amount data is described.

The discharge amount data can be obtained by measuring the discharge amount of curable ink for each nozzle.

The measurement of the discharge amount may be performed by any method. As the method of measuring the discharge amount, there is exemplified a method of measuring the weight of curable ink discharged through a plurality of nozzles using a precise balance after sequentially discharging the curable ink several times for each nozzle or a method of converting the dot diameter of ink discharged and then landed onto the surface of paper, plastic substrate or metal substrate having an ink receiving layer to weight.

For example, the discharge amount data is created based on the results obtained by measuring the thickness of a predetermined test pattern of curable ink in the discharge direction, this test pattern be formed by discharging curable ink through a plurality of nozzles.

Specifically, a droplet discharge head using a piezoelectric element deformed by the application of a voltage is fixed at a certain position, and the discharge and curing of curable ink are repeated a predetermined number of times, thus forming a test piece on a metal, glass, or plastic substrate. The height of the obtained test piece (height of curable ink in the discharge direction) is measured using a laser displacement meter or the like. In addition, height variation data is created as discharge amount data of a plurality of nozzles. According to this method, it is possible to create a plurality of accurate nozzle data, thereby further improving the dimensional accuracy of a three-dimensional structure to be manufactured. Further, the droplet discharge head is generally fixed, but it may not be fixed in accordance with the test pattern.

Further, according to this method, it is possible to obtain discharge amount data in which the cure shrinkage of several kinds of curable ink discharged is considered. It is possible to correct three-dimensional data using this data. For example, in the case where the difference in cure shrinkage between several kinds of curable ink is large, even when the discharge amounts of curable ink are approximately same, the thickness of a layer or the unevenness of surface of a layer is influenced at the time of curing. However, by correcting the three-dimensional data using the discharge amount data in which cure shrinkage is considered, it is possible to further improve the dimensional accuracy of a three-dimensional structure to be manufactured.

In the present embodiment, the correction of three-dimensional data is performed by correcting the three-dimensional data on the basis of obtained discharge amount data and discharge position information of nozzles. Thus, the dimensional accuracy of a three-dimensional structure to be manufactured can be made higher.

Specifically, three-dimensional data 1 (refer to FIG. 1A), which is the original data of the entire three-dimensional structure, is formed into correction data 2 (refer to FIG. 1B) in accordance with the discharge amount data of a plurality of nozzles and the discharge positions of the plurality of nozzles assigned to the three-dimensional data. In this case, in the position of three-dimensional data to which nozzles having a larger discharge amount than predetermined discharge amount are assigned, the thickness of a layer decreases. In contrast to this, in the position of three-dimensional data to which nozzles having a smaller discharge amount than predetermined discharge amount are assigned, the thickness of a layer increases. Then, the correction data is divided at a predetermined interval to create a large number of two-dimensional sectional layer data.

Further, the original data of the entire three-dimensional structure to be manufactured is divided into a large number of two-dimensional cross-sectional layers to form two-dimensional sectional layer data, and then the two-dimensional sectional layer data may be corrected in accordance with the above-mentioned discharge amount data and the discharge positions of the plurality of nozzles assigned to the three-dimensional data. In this case, in the two-dimensional sectional layer data of the position at which curable ink is discharged from the nozzles having a larger discharge amount than the setting value, the thickness of a layer decreases. In contrast to this, in the two-dimensional sectional layer data of the position at which curable ink is discharged from the nozzles having a smaller discharge amount than the setting value, the thickness of a layer increases.

Meanwhile, in the ink discharge process, the discharge process can be performed using the differential data of discharge amount of the nozzle having the maximum discharge amount of each of nozzles and discharge amount of each of the other nozzles, followed by the discharge process of the two-dimensional sectional layer data. That is, the discharge amount is adjusted based on the nozzle having the maximum discharged amount. Thus, the correction of discharge amount of each nozzle can be easily performed. The discharge process using the differential data may be performed once or several times. In addition, the discharge process may also be performed by data in which the two-dimensional sectional layer data and the differential data are combined in advance. The correction of the discharge amount may be performed by forming a two-dimensional sectional layer data to be added to the position corresponding to the nozzle having insufficient discharge amount and adding a discharge process for correction once or several times.

In addition, in the ink discharge process, the discharge process can be performed using the differential data of discharge amount of the nozzle having the minimum discharge amount of each of nozzles and discharge amount of each of the other nozzles, followed by the discharge process of the two-dimensional sectional layer data. That is, the discharge amount is adjusted based on the nozzle having the minimum discharged amount. Thus, the correction of discharge amount of each nozzle can be easily performed. The discharge process using the differential data may be performed once or several times. In addition, the discharge process may also be performed by data in which the two-dimensional sectional layer data and the differential data are combined in advance. The correction of discharge amounts may be performed once over several times in combination with a discharge process for correcting two-dimensional sectional layer data subtracting data at the position corresponding to nozzles having excessive discharge amounts.

In addition, in the ink discharge process, the discharge process can be performed by the correction data based on the difference between the average discharge amount of a plurality of nozzles and the discharge amount of each nozzle. That is, the discharge amount is adjusted based on the average discharge amount of nozzles. Thus, the correction of discharge amount of each nozzle can be easily performed. The discharge process using the differential data may be performed once or several times. In addition, the discharge process may also be performed by data in which the two-dimensional sectional layer data and the differential data are combined in advance. The correction of discharge amounts, at the position corresponding to nozzles having insufficient discharge amounts, may be performed once over several times by the addition of a discharge process for correction, and, at the position corresponding to nozzles having excessive discharge amounts, may be performed once over several times in combination with a discharge process for correcting two-dimensional sectional layer data subtracting data.

### Ink Discharge Process

Next, based on the two-dimensional sectional layer data subjected to the above-mentioned the discharge amount correction, curable ink is discharged by an ink jet method to form an ink layer (ink discharge process).

The amount of ink discharged in this process is not particularly limited, but is set such that the thickness of a unit layer formed in the following curing process is preferably 10 μm or more and 500 μm or less, and more preferably 30 μm or more and 150 μm or less. Thus, the productivity of the three-dimensional structure 10 can be sufficiency improved, and the dimensional accuracy thereof can also be particularly improved.

As the droplet discharge method (ink jet method), a piezo method, a method of discharging ink using the bubbles generated by heating ink, or the like can be used, but, from the viewpoint of the constituents of curable ink not being easily deteriorated, a piezoelectric method is preferable.

### Curing Process (Unit Layer Formation Process)

The curing component (curable resin) contained in the ink layer formed in the ink discharge process is cured. Thus, a unit layer is obtained.

The three-dimensional structure finally obtained by curing the curing component (curable resin) contained in the ink in this process is composed of a cured material. Therefore, this three-dimensional structure is excellent in mechanical strength, durability, or the like, compared to a three-dimensional structure composed of a thermoplastic resin.

When the curing component (curable resin) is a thermosetting resin although it is different depending on the kind thereof, this process can be carried out by heating. When the curing component (curable resin) is a photocurable resin, this process can be carried out by irradiation of the corresponding light (for example, when the curing component (curable resin) is an ultraviolet curable resin, this process can be carried out by irradiation of ultraviolet).

Meanwhile, in the above description, a case that ink is applied in a shape or pattern corresponding to the unit layer and then the entire ink layer is cured has been exemplified, but, in the invention, the discharge of ink and the curing of ink may be simultaneously carried out for at least part of area. That is, before a pattern is formed over the entire unit layer, for at least part of the area corresponding to the unit layer, curing reactions may sequentially proceed from the site where the ink has been applied.

The above series of processes are repeatedly carried out. Thus, adjacent unit layers are attached to each other, thereby obtaining a laminate in which the plurality of unit layers 1 are laminated, that is, a three-dimensional structure.

According to the method of manufacturing a three-dimensional structure of the invention, the variation in thickness of unit layers attributable to the variation in discharge amount of nozzles can be suppressed, thus manufacturing a three-dimensional structure having high dimensional accuracy.

### 2. Curable Ink

The curable ink contains at least a curable resin (curing component).

### Curable Resin

Examples of the curable resin (curing component) include: thermosetting resins; various photocurable resins such as visible light curable resin cured by light in the visible light region (narrowly-defined photocurable resin), ultraviolet curable resin, and infrared curable resin; and X-ray curable resins. They can be used alone or in a combination of two or more thereof.

Among them, in terms of the mechanical strength and productivity of the three-dimensional structure to be obtained and the storage stability of the curable ink, an ultraviolet curable resin (polymerizable compound) is particularly preferable.

As the ultraviolet curable resin (polymerizable compound), an ultraviolet curable resin in which addition polymerization or ring-opening polymerization is initiated by radicals or cations derived from a photopolymerization initiator by ultraviolet irradiation to form a polymer is preferably used. Examples of addition polymerization include radical polymerization, cationic polymerization, anionic polymerization, metathesis polymerization, and coordination polymerization. Further, examples of ring-opening polymerization include cationic polymerization, anionic polymerization, radical polymerization, metathesis polymerization, and coordination polymerization.

An example of the addition-polymerizable compound includes a compound having at least one ethylenically unsaturated double bond. As the addition-polymerizable compound, a compound having at least one of terminal ethylenically unsaturated double bonds, or two or more thereof is preferably used.

The ethylenically unsaturated polymerizable compound has a chemical form of a monofunctional polymerizable compound, a multifunctional polymerizable compound, or a mixture thereof.

Examples of the monofunctional polymerizable compound include unsaturated carboxylic acids (for example, acrylic acid, methacrylic acid, itaconic acid, crotonic acid, isocrotonic acid, maleic acid, and the like), esters thereof, and amides thereof.

Examples of the multifunctional polymerizable compound include esters of unsaturated carboxylic acids and aliphatic polyalcohol compounds, and amides of unsaturated carboxylic acids and aliphatic amine compounds.

In addition, examples thereof include unsaturated carboxylic acid esters or amides having a nucleophilic substituent such as a hydroxyl group, an amino group, or mercapto group, isocyanates, addition reaction products of epoxies, dehydration condensation reaction products of carboxylic acids. Further, examples thereof include unsaturated carboxylic acid esters or amides having an electrophilic substituent such as an isocyanate group or an epoxy group, alcohols, and addition reaction products of amines and thiols. Moreover, examples thereof include unsaturated carboxylic acid esters or amides having a leaving substituent such as a halogen group or a tosyloxy group, alcohols, and substitution reaction products of amines or thiols.

Specific examples of the radical polymerizable compound, which is an ester of unsaturated carboxylic acid and an aliphatic polyalcohol compound, typically includes (meth)acylic esters. These (meth)acrylates may be monofunctional (meth)acrylic esters or multifunctional (meth)acrylic esters.

Specific examples of monofunctional (meth)acrylates include tolyloxyethyl (meth) acrylate, phenyloxyethyl (meth)acrylate, cyclohexyl (meth)acrylate, ethyl (meth)acrylate, methyl (meth)acrylate, isobornyl (meth) acrylate, dipropyleneglycol di(meth)acrylate, tetrahydrofurfuryl (meth) acrylate, ethoxyethoxyethyl (meth) acrylate, (meth)acrylic acid 2-(2-vinyloxyethoxyl) ethyl, 2-hydroxy-3-phenoxypropyl (meth) acrylate, 4-hydroxybutyl (meth)acrylate, and the like.

Specific examples of bifunctional (meth)acrylates include ethyleneglycol di(meth)acrylate, triethyleneglycol di(meth)acrylate, 1,3-butanediol di(meth)acrylate, tetramethyleneglycol di(meth)acrylate, propyleneglycol di(meth)acrylate, neopentylglycol di(meth)acrylate, hexanediol di(meth)acrylate, 1,4-cyclohexanediol di(meth)acrylate, tetraethyleneglycol di(meth)acrylate, pentaerythritol di(meth)acrylate, dipentaerythritol di (meth) acrylate, and the like.

Specific examples of trifunctional (meth)acrylates include trimethylolpropane tri(meth)acrylate, trimethylolethane tri(meth)acrylate, alkyleneoxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkyleneoxide-modified tri(meth)acrylate, propionic acid dipentaerythritol tri(meth)acrylate, tri((meth)acryloyloxyethyl) isocyanurate, hydroxypivalaldehyde-modified dimethylolpropane tri(meth)acrylate, sorbitol tri(meth)acrylate, and the like.

Specific examples of tetrafunctional (meth) acrylates include pentaerythritol tetra(meth)acrylate, sorbitol tetra(meth)acrylate, ditrimethylolpropane tetra(meth)acrylate, dipentaerythritolpropionate tetra(meth)acrylate, ethoxylated pentaerythritol tetra(meth)acrylate, and the like.

Specific examples of pentafunctional (meth) acrylates include sorbitol penta(meth)acrylate, dipentaerythritol penta(meth)acrylate, and the like.

Specific examples of hexafunctional (meth)acrylates include dipentaerythritol hexa(meth)acrylate, sorbitol hexa(meth)acrylate, alkyleneoxide-modified hexa(meth)acrylate of phosphazene, caprolactone-modified dipentaerythritol hexa(meth)acrylate, and the like.

Examples of polyemizable compounds other than (meth)acrylates include itaconic acid esters, crotonic acid esters, isocrotonic acid esters, maleic acid esters, and the like.

Examples of itaconic acid esters include ethyleneglycol diitaconate, propyleneglycol diitaconate, 1,3-butanediol diitaconate, 1,4-butanediol diitaconate, tetramethyleneglycol diitaconate, pentaerythritol diitaconate, sorbitol tetraitaconate, and the like.

Examples of crotonic acid esters include ethyleneglycol dicrotonate, tetramethyleneglycol dicrotonate, pentaerythritol dicrotonate, sorbitol tetracrotonate, and the like.

Examples of isocrotonic acid esters include ethyleneglycol isocrotonate, pentaerythritol diisocrotonate, sorbitol tetraisocrotonate, and the like.

Examples of maleic acid esters include ethyleneglycol dimaleate, triethyleneglycol dimaleate, pentaerythritol dimaleate, sorbitol tetramalate, and the like.

Examples of other esters include aliphatic alcohol-based esters disclosed in JP-B-46-27926, JP-B-51-47334, and JP-A-57-196231; esters having an aromatic skeleton disclosed in JP-A-59-5240, JP-A-59-5241, and JP-A-2-226149; and esters having an amino group disclosed in JP-A-1-165613.

Specific examples of monomers of amides of unsaturated carboxylic acids and aliphatic amide compounds include methylene bis-acrylamide, methylene bis-methacrylamide, 1,6-hexamethylene-bis-acrylamide, 1,6-hexamethylene-bis-methacrylamide, diethylenetriamine trisacrylamide, xylylene bis-acrylamide, xylylene bis-methacrylamide, (meth)acryloyl morpholine, and the like.

Examples of other preferable amide-based monomers include amide-based monomers having a cyclohexylene structure disclosed in JP-B-54-21726.

In addition, urethane-based addition-polymerizable compounds produced by the addition reaction of isocyanate and a hydroxyl group are also preferable, and a specific example thereof includes a vinyl urethane compound having two or more polymerizable vinyl groups in one molecule, which is produced by adding a hydroxyl-containing vinyl monomer represented by the following Formula (1) to a polyisocyanate compound having two or more isocyanate groups in one molecule disclosed in JP-B-48-41708.

CH₂═C(R¹)COOCH₂CH(R²)OH (1)

(Here, R¹ and R² each independently represent H or CH₃.)

In the invention, a cationic ring-opening polymerizable compound having at least one cyclic ether group such as an epoxy group or an oxetane group in a molecule can be preferably used as the ultraviolet curable resin (polymerizable compound).

Examples of cationic polymerizable compounds include curable compounds containing a ring-opening polymerizable group. Among them, curable compounds containing a heterocyclic group are particularly preferable. Examples of these curable compounds include cyclic imino ethers such as epoxy derivative, oxetane derivatives, tetrahydrofuran derivatives, cyclic lactone derivatives, cyclic carbonate derivatives, and oxazoline derivatives; and vinyl ethers. Among them, epoxy derivative, oxetane derivatives, and vinyl ethers are preferable.

Preferred examples of epoxy derivatives include monofunctional glycidyl ethers, multifunctional glycidyl ethers, monofunctional alicyclic epoxies, and multifunctional alicyclic epoxies.

Specific examples of glycidyl ethers include diglycidyl ethers (for example, ethyleneglycol diglycidyl ether, bisphenol A diglycidyl ether, and the like), tri- or higher functional glycidyl ethers (for example, trimethylol ethane triglycidyl ether, trimethylolpropane triglycidyl ether, glycerol triglycidyl ether, triglycidyl trishydroxyethyl isocyanurate, and the like), tetra- or higher functional glycidyl ethers (for example, sorbitol tetraglycidyl ether, pentaerythritol tetraglycidyl ether, polyglycidyl ethers of cresol novolac resins, polyglycidyl ethers of phenol novolac resin, and the like), alicyclic epoxies (for example, CELLOXIDE 2021P, CELLOXIDE 2081, EPOLEAD GT-301, and EPOLEAD GT-401 (all are manufactured by Daicel Corporation)), EHPE (manufactured by Daicel Corporation), polycyclohexyl epoxymethyl ethers of phenol novolac resins, and oxetanes (for example, OX-SQ and PNOX-1009 (all are manufactured by Toagosei. Co., Ltd.)).

As polymerizable compounds, alicyclic epoxy derivatives can be preferably used. The “alicyclic epoxy group” refers to a partial structure in which a double bond of a cycloalkene ring such as a cyclopentene group or a cyclohexene group is epoxidized with a suitable oxidizing agent such as hydrogen peroxide or peracid.

As alicyclic epoxy compounds, multifunctional alicyclic epoxies having two or more cyclohexene oxide groups or cyclopentene oxide groups in one molecule are preferable. Specific examples of alicyclic epoxy compounds include 4-vinyl cyclohexene dioxide, (3,4-epoxycyclohexyl)methyl-3,4-epoxycyclohexyl carboxylate, di(3,4-epoxycyclohexyl) adipate, di(3,4-epoxycyclohexylmethyl) adipate, bis(2,3-epoxycyclopentyl) ether, di(2,3-epoxy-6-methylcyclohexylmethyl) adipate, and dicyclopentadiene dioxide.

A general glycidyl compound having an epoxy group, having no alicyclic structure in a molecule, can be used independently or in the combination with the above alicyclic epoxy compound.

Examples of the general glycidyl compounds include glycidyl ether compounds and glycidyl ester compounds, but, preferably, a glycidyl ether compound is used the combination with the above alicyclic epoxy compound.

Specific examples of glycidyl ether compounds include aromatic glycidyl ether compounds such as 1,3-bis(2,3-epoxypropyloxy)benzene, bisphenol A type epoxy resins, bisphenol F type epoxy resins, phenol novolac epoxy resins, cresol novolac type epoxy resins, trisphenolmethane type epoxy resins; and aliphatic glycidyl ether compounds such as 1,4-butanediol glycidyl ether, glycerol triglycidyl ether, propyleneglycol diglycidyl ether, and trimethylolpropane triglycidyl ether. Examples of glycidyl esters include glycidyl esters of linolenic acid dimers.

As the polymerizable compound, a compound having an oxetanyl group (4-membered cyclic ether) (hereinafter, simply referred to as “oxetane compound”) can be used. The compound having an oxetanyl group is a compound having one or more oxetanyl groups in one molecule.

Preferably, the curable ink contains one or two or more selected from the group consisting of 2-(2-vinyloxyethoxyl)ethyl (meth) acrylate, a polyether-based aliphatic urethane (meth)acrylate oligomer, 2-hydroxy-3-phenoxypropyl (meth)acrylate, and 4-hydroxybutyl (meth)acrylate. Thus, it is possible to cure the curing ink at a more suitable curing rate, and, particularly, it is possible to provide excellent productivity of the three-dimensional structure. Further, it is possible to improve the strength, durability and reliability of a three-dimensional structure.

Particularly, when the curable ink contains 2-(2-vinyloxyethoxyl)ethyl (meth)acrylate, curing can be conducted at low energy because it is less susceptible to oxygen inhibition. Further, copolymerization including other monomers is accelerated, and thus effects of increasing the strength of the three-dimensional structure can be obtained.

In addition, when the curable ink contains a polyether-based aliphatic urethane (meth)acrylate oligomer, effects of achieving both high strength and high toughness of the three-dimensional structure can be obtained.

Further, when the curable ink contains 2-hydroxy-3-phenoxypropyl (meth)acrylate, effects of improving flexibility and breaking elongation of the three-dimensional structure can be obtained.

Moreover, when the curable ink contains 4-hydroxybutyl (meth)acrylate, the adhesion of PMMA particles, PEMA particles, silica particles, or metal particles added to the self-cured product formed in the previous layer is improved, thereby obtaining the effect of increasing the strength of the three-dimensional structure.

When the curable ink contains the above-mentioned specific curing components, that is, one or two or more selected from the group consisting of 2-(2-vinyloxyethoxyl)ethyl (meth) acrylate, a polyether-based aliphatic urethane (meth)acrylate oligomer, 2-hydroxy-3-phenoxypropyl (meth)acrylate, and 4-hydroxybutyl (meth)acrylate, the ratio of the specific curing component to all of the curing components constituting the curable ink is preferably 80 mass % or more, more preferably 90 mass % or more, and still more preferably 100 mass %. Thus, the above-mentioned effects can be more remarkably exhibited.

The content of the curing component in the curable ink is preferably 80 mass % to 97 mass %, and more preferably 85 mass % to 95 mass %.

Thus, the mechanical strength of the three-dimensional structure to be finally obtained can be particularly excellent. Further, the productivity of the three-dimensional structure can be particularly excellent. Polymerization initiator

Preferably, the curable ink contains a polymerization initiator.

Thus, at the time of manufacturing a three-dimensional structure, it is possible to accelerate the curing rate of the curable ink, and, particularly, it is possible to provide excellent productivity of the three-dimensional structure.

As the polymerization initiator, a photo-radical polymerization initiator (aromatic ketones, acylphosphine oxide compounds, aromatic onium salt compounds, organic peroxides, thio compounds (thioxanthone compound, a thiophenyl group-containing compound, and the like), hexaarylbiimidazole compounds, ketoxime ester compounds, borate compounds, azinium compounds, metallocene compounds, active ester compounds, compounds having a carbon-halogen bond, alkyl amine compound, and the like) or a photo-cationic polymerization initiator can be used. Specific examples thereof include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chloro benzophenone, 4,4′-dimethoxy benzophenone, 4,4′-diamino benzophenone, Michler's ketone, benzoin propyl ether, benzoin ethyl ether, benzyl dimethyl ketal, 1-(4-isopropyl-phenyl)-2-hydroxy-2-methylpropan-1-one, 2-hydroxy-2-methyl-1-phenylpropan-1-one, thioxanthone, diethyl thioxanthone, 2-isopropyl thioxanthone, 2-chloro thioxanthone, 2-methyl-1-[4-(methylthio)phenyl]-2-morpholino-propan-1-one, bis(2,4,6-trimethyl benzoyl)-phenyl phosphine oxide, 2,4,6-trimethyl benzoyl-diphenyl-phosphine oxide, 2,4-diethyl thioxanthone, bis-(2,6-dimethoxy-benzoyl)-2,4,4-trimethylpentylphosphine oxide, and the like. They can be used alone or in a combination of two or more thereof.

Among them, it is preferable that the polymerization initiator constituting the curable ink contains bis(2,4,6-trimethylbenzoyl)-phenyl phosphineoxide, and 2,4,6-trimethyl benzoyl-diphenyl-phosphine oxide.

By containing this polymerization initiator, it is possible to cure the curing ink at a more suitable curing rate, and, particularly, it is possible to provide excellent productivity of the three-dimensional structure. Further, it is possible to improve the strength, durability and reliability of a three-dimensional structure.

The specific value of the content ratio of the polymerization initiator in the curable ink is preferably 3.0 wt % to 18 wt %, and more preferably 5.0 wt % to 15 wt %. Thus, it is possible to cure the curing ink at a more suitable curing rate, and, particularly, it is possible to provide excellent productivity of the three-dimensional structure. Further, it is possible to improve the strength, durability and reliability of a three-dimensional structure.

Hereinafter, a preferred example of the mixing ratio of curable resin and polymerization initiator in the curable ink (ink composition excluding the following “other components”) is exemplified, but the composition of the curable ink in the invention is not limited thereto.

### Example of Mixing Ratio

2-(2-vinyloxyethoxyl)ethyl acrylate: 32 parts by mass

polyether-based aliphatic urethane acrylate oligomer: 10 parts by mass
2-hydroxy-3-phenoxypropyl acrylate: 13.75 parts by mass
dipropylene glycol diacrylate: 15 parts by mass
4-hydroxybutyl acrylate: 20 parts by mass
bis (2,4,6-trimethylbenzoyl)-phenyl-phosphine oxide: 5 parts by mass
2,4,6-trimethylbenzoyl-diphenyl-phosphine oxide: 4 parts by mass

In the case of this mixing ratio, the above-mentioned effects are remarkably exhibited.

### Other Components

The curable ink may contain other components in addition to the above-mentioned components.

Examples of these components include various colorants such as pigment and dyes; dispersants; surfactants; sensitizers; polymerization accelerators; solvents; penetration enhancers; wetting agents (humectants); fixing agents; antifungal agents; preservatives; antioxidants; UV absorbers; chelating agents; pH adjusting agents; thickeners; fillers; aggregation inhibitors; and defoamers.

Particularly, when the curable ink contains the colorant, it is possible to obtain a three-dimensional structure colored by a color corresponding to the color of the colorant.

Particularly, when the curable ink contains pigment as the colorant, it is possible to make the light resistance of the curable ink or the three-dimensional structure good. As the pigment, both inorganic pigments and organic pigments can be used.

Examples of inorganic pigments include carbon blacks (C.I. Pigment Black 7) such as furnace black, lamp black, acetylene black, and channel black; iron oxide; and titanium oxide. They can be used alone or in a combination of two or more thereof.

Among these inorganic pigments, in order to exhibit preferred white color, titanium oxide is preferable.

Examples of organic pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, quinophthalone pigments; dye chelates (for example, basic dye chelates, acidic dye chelates, and the like); staining lakes (basic dye lakes, acidic dye lakes); nitro pigments; nitroso pigments; aniline blacks; and daylight fluorescent pigments. They can be used alone or in a combination of two or more thereof.

More specifically, Examples of carbon black used as black pigment include No. 2300, No. 900, MCF88, No. 33, No. 40, No. 45, No. 52, MA7, MA8, MA100, and No. 2200B (all are manufactured by Mitsubishi Chemical Corporation); Raven 5750, Raven 5250, Raven 5000, Raven 3500, Raven 1255, and Raven 700 (all are manufactured by Carbon Columbia Co., Ltd.); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all are manufactured by CABOT JAPAN K.K.); and Color Black FW1, Color Black FW2, Color Black FW2V, Color Black FW18, Color Black FW200, Color Black 5150, Color Black S160, Color Black S170, Printex 35, Printex U, Printex V, Printex 140U, Special Black 6, Special Black 5, Special Black 4A, and Special Black 4 (all are manufactured by Degussa Co., Ltd.).

Examples of white pigment include C.I. Pigment White 6, 18, and 21.

Examples of yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of red-violet (magenta) pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57: 1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violet 19, 23, 32, 33, 36, 38, 43, and 50.

Examples of blue (cyan) pigment include C.I. Pigment Blue 1, 2, 3, 15, 15:1, 15:2, 15:3, 15:34, 15:4, 16, 18, 22, 25, 60, 65, and 66; and C.I. Bat Blue 4 and 60.

Examples of pigments other than the above pigments include C.I. Pigment Green 7 and 10; C.I. Pigment Brown 3, 5, 25, and 26; and C.I. Pigment Orange 1, 2, 5, 7, 13, 14, 15, 16, 24, 34, 36, 38, 40, 43, and 63.

When the curable ink contains a pigment, the average particle diameter of the pigment is preferably 300 nm or less, and more preferably 50 nm or more and 250 nm or less.

Thus, the discharge stability of the curable ink and the dispersion stability of the pigment in the curable ink can be particularly excellent, and images with better image quality can be formed.

Examples of dyes include acid dyes, direct dyes, reactive dyes, and basic dyes. They can be used alone or in a combination of two or more thereof.

Specific examples of dyes include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

When the curable ink contains a colorant, the content ratio of the colorant in the curable ink is preferably 1 mass % to 20 mass %. Thus, excellent hiding properties and color reproducibility are obtained.

Particularly, when the curable ink contains titanium oxide as the colorant, the content ratio of titanium oxide in the curable ink is preferably 12 mass % to 18 mass %, and more preferably 14 mass % to 16 mass %. Thus, particularly excellent hiding properties are obtained.

When the curable ink contains a dispersant in addition to a pigment, the dispesibility of the pigment can be further improved.

The dispersant is not particularly limited, but examples thereof include dispersants, such as polymer dispersant, generally used in preparing a pigment dispersion.

Specific examples of the polymer dispersants include polymer dispersants containing one or more of polyoxyalkylene polyalkylene polyamine, vinyl polymers and copolymers, acrylic polymers and copolymers, polyesters, polyamides, polyimides, polyurethanes, amino-based polymers, silicon-containing polymers, sulfur-containing polymers, fluorinated polymers, and epoxy resins, as main component.

Examples of commercially products of polymer dispersants include AJISPER series of Ajinomoto Fine-techno Co., Inc.; Solspers series (Solsperse 36000 and the like) commercially available from Noveon Corporation; DISPERBYK series of BYK Japan K.K.; and DISPERBYK series of Kusumoto Chemicals, Ltd.

When the curable ink contains a surfactant, the abrasion resistance of the three-dimensional structure can be better.

The surfactant is not particularly limited, but examples thereof include silicone-based surfactants such as polyester-modified silicone, polyether-modified silicone, and the like. Among them, polyether-modified polydimethylsiloxane or polyester-modified polydimethylsiloxane is preferably used.

Specific examples of the surfactant include BYK-347, BYK-348, BYK-UV3500, 3510, 3530, and 3570 (all are trade names of BYK Japan K.K.).

The curable ink may contain a solvent.

Thus, the viscosity of the curable ink can be suitably adjusted, and the discharge stability of the curable ink by an ink jet method can be particularly excellent even when it contains a component having high viscosity.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetic acid esters, such as ethyl acetate, n-propyl acetate, iso-propyl acetate, n-butyl acetate, and iso-butyl acetate; aromatic hydrocarbons such as benzene, toluene, and xylene; ketones, such as methyl ethyl ketone, acetone, methyl isobutyl ketone, ethyl-n-butyl ketone, diisopropyl ketone, and acetylacetone; alcohols, such as ethanol, propanol, and butanol. They can be used alone or in a combination of two or more thereof.

The viscosity of the curable ink is preferably 10 mPa·s to 30 mPa·s, and more preferably 15 mPa·s to 25 mPa·s.

Thus, the discharge stability of the curable ink by an ink jet method can be particularly excellent. In the present specification, viscosity refers to a value measured at 25° C. using an E-type viscometer (VISCONIC ELD, manufactured by Tokyo Keiki Inc.).

Meanwhile, in the manufacture of the three-dimensional structure, several kinds of curable ink may be used.

For example, curable ink (color ink) containing a colorant and curable ink (clear ink) containing no colorant may be used.

Thus, for example, for the appearance of the three-dimensional structure, the curable ink containing a colorant can be used as a curable ink applied to the region influencing color tone, and, for the appearance of the three-dimensional structure, the curable ink containing no colorant can be used as a curable ink applied to the region not influencing color tone. It is advantageous in terms of reducing the production cost of the three-dimensional structure.

Further, in the three-dimensional structure to be finally obtained, several kinds of curable inks may be used in combination with each other such that the region (coating layer) formed using the curable ink containing no colorant is provided on the outer surface of the region formed using the curable ink containing a colorant. Thus, the change in color tone of the three-dimensional structure can be efficiently prevented and suppressed even when the surface of the three-dimensional structure is worn by long-term use.

For example, several kinds of curable inks containing colorants having different compositions from each other may be used.

Thus, a wider color reproducing area that can be expressed can be realized by the combination of these curable inks.

When the several kinds of curable inks are used, it is preferable that at least indigo-violet (cyan) curable ink, red-violet (magenta) curable ink, and yellow curable ink are used.

Thus, a wider color reproducing area that can be expressed can be realized by the combination of these curable inks.

Further, for example, the following effects are obtained by the combination of white curable ink and other colored curable ink.

That is, the three-dimensional structure to be finally obtained can have a first area on which white curable ink is applied, and a second area which is provided on the outside of the first area and on which curable ink having a color other than white color is applied. Thus, the first area on which white curable ink is applied can exhibit hiding properties, and the color saturation of the three-dimensional structure can be enhanced.

In addition, the above-mentioned effect of obtaining fine texture and the effect of enhancing the color saturation of the three-dimensional structure are synergistically operated, thereby making the aesthetic appearance (sensuousness) of the three-dimensional structure particularly excellent.

### 3. Three-Dimensional Structure

The three-dimensional structure of the invention can be manufactured using the above-mentioned method. Thus, it is possible to provide a three-dimensional structure manufactured with high dimensional accuracy.

Applications of the three-dimensional structure of the invention are not particularly limited, but examples thereof appreciated and exhibited objects such as dolls and figures; and medical instruments such as implants; and the like.

In addition, the three-dimensional structure of the invention may be applied to prototype, mass-produced products, made-to-order goods, and the like.

Further, the three-dimensional structure of the invention may be used as models (for example, models of vehicles such as automobiles, motorcycles, boats and airplanes, buildings, creatures such as animals and plants, natural materials (non-living materials) such as stone, and various foods).

Although preferred embodiments of the invention have been described, the invention is not limited thereto.

For example, in the method of manufacturing a three-dimensional structure according to the invention, if necessary, pre-treatment, intermediate treatment, and post-treatment processes may be performed.

An example of the pre-treatment process include a process of cleaning stage, and examples of the post-treatment process include a cleaning process, a shape adjustment process for deburring, an additional curing process for increasing the curing degree of a curable resin, and the like.

In addition, the invention may be applied to a powder lamination method (that is, a method of obtaining a three-dimensional structure as a laminate having a plurality of layers provided with a cured unit by forming a layer using powder, applying a curable ink onto the predetermined portion of the layer to form the cured unit and repeating this serial operations).

The entire disclosure of Japanese Patent Application No. 2014-063431, filed Mar. 26, 2014 is expressly incorporated by reference herein.

What is claimed is:

1. A method of manufacturing a three-dimensional structure using three-dimensional data, comprising:
discharging ink containing a curable resin from a droplet discharge head having a plurality of nozzles;
curing the discharged ink; and
measuring discharge amounts of the ink in the plurality of nozzles to create discharge amount data;
wherein the three-dimensional data is corrected based on the discharge amount data.

2. The method of manufacturing a three-dimensional structure according to claim 1,
wherein the discharge amount data is created based on the results obtained by discharging the ink from the plurality of nozzles to form a predetermined test pattern and then measuring the height of the test pattern of the ink in a discharge direction.

3. The method of manufacturing a three-dimensional structure according to claim 1,
wherein, in the ink discharge process, when several kinds of ink are discharged, the discharge amount data are corrected using values of cure shrinkage of the several kinds of ink.

4. The method of manufacturing a three-dimensional structure according to claim 1,
wherein the three-dimensional data are corrected based on the discharge amount data and discharge position information of the plurality of nozzles.

5. The method of manufacturing a three-dimensional structure according to 1, further comprising:
creating two-dimensional sectional layer data by dividing the three-dimensional data of the three-dimensional structure into a plurality of two dimensional sectional layers,
wherein the two-dimensional sectional layer data are corrected based on the discharge amount data and discharge position information of the plurality of nozzles.

6. The method of manufacturing a three-dimensional structure according to 1, further comprising:
creating two-dimensional sectional layer data by dividing the three-dimensional data of the three-dimensional structure into a plurality of two dimensional sectional layers,
wherein, in the ink discharge process, the process is performed by superimposing the differential data of discharge amount of the nozzle having the maximum discharge amount of the plurality of nozzles and discharge amount of each of the plurality of other nozzles on a portion of the two-dimensional sectional layer data, the portion corresponding to the plurality of other nozzles.

7. The method of manufacturing a three-dimensional structure according to 1, further comprising:
creating two-dimensional sectional layer data by dividing the three-dimensional data of the three-dimensional structure into a plurality of two dimensional sectional layers,
wherein, in the ink discharge process, the process is performed by subtracting the differential data of discharge amount of the nozzle having the maximum discharge amount of the plurality of nozzles and discharge amount of each of the plurality of other nozzles from a portion of the two-dimensional sectional layer data, the portion corresponding to the plurality of nozzles.

8. The method of manufacturing a three-dimensional structure according to 1, further comprising:
creating two-dimensional sectional layer data by dividing the three-dimensional data of the three-dimensional structure into a plurality of two dimensional sectional layers,
wherein, in the ink discharge process, a portion of the two-dimensional sectional layer data, the portion corresponding to the plurality of nozzles, is corrected based on the differential data of the average discharge amount of the plurality of nozzles and the discharge amount of each of the plurality of nozzles.

9. A three-dimensional structure, which manufactured by the method according to claim 1.

10. A three-dimensional structure, which manufactured by the method according to claim 2.

11. A three-dimensional structure, which manufactured by the method according to claim 3.

12. A three-dimensional structure, which manufactured by the method according to claim 4.

13. A three-dimensional structure, which manufactured by the method according to claim 5.

14. A three-dimensional structure, which manufactured by the method according to claim 6.

15. A three-dimensional structure, which manufactured by the method according to claim 7.

16. A three-dimensional structure, which manufactured by the method according to claim 8.
